(19) United States
(12) Patent Application Publication
(10) Pub. No.: US 2009/0000493 A1
(43) Pub. Date: Jan. 1, 2009

(54) ROTISSERIE OVEN FOR A GRILL

(75) Inventor: Robert F. Mosher, II, Wichita, KS (US)

Correspondence Address: Kelly S.K. Elsea;Intellectual Property Counsel for, The Coleman Company, Inc., 3600 N. Hydraulic, Wichita, KS, 67219, US

(73) Assignee: THE COLEMAN COMPANY, INC., Wichita, KS (US)

(21) Appl. No.: 11/771,900

(22) Filed: Jun. 29, 2007

(51) Int. Cl. A47J 37/04

(52) U.S. Cl. 99/421 R; 126/25 R; 99/447

(57) ABSTRACT

A rotisserie oven. The rotisserie oven includes a cooking chamber, a spit, a motor assembly, and a fuel burning burner. The motor assembly rotates the spit about an axle. The spit is located horizontally in the cooking chamber so that any liquids dripping from any food on the spit do not fall on the burner. The spit may be removed and replaced by a grate and a heat shield. The grate is oriented horizontally inside the cooking chamber and the heat shield distributes heat from the burner evenly about the grate. The rotisserie oven may be configured to be removably attached to a grill.

### BACKGROUND OF THE INVENTION

Outdoor grilling is a popular way to cook foods, especially in warmer weather. Conventional grills utilize charcoal or wood, or may use liquid fuels, such as gas or propane. Most large outdoor grills that are used for backyard cooking include a firebox mounted about waist high on a frame. The frame typically includes wheels so that the grill may be rolled to a convenient location in the yard. An example of a grill can be found in PCT/US06/62248, filed on Dec. 18, 2006, by inventors Stuart L. Meether, David C. Thornhill, Paul A. Grimes, and Robert F. Mosher II.

Conventional outdoor grills come in a variety of sizes and shapes, with various accessories. One problem with conventional grills is that a purchaser may have to make a decision between quality and accessories due to price constraints. As an example, a potential purchaser may want to buy a high quality grill, but cannot afford such a grill with all the accessories that the purchaser would like. The potential purchaser must make a decision between purchasing a high quality grill without accessories, or a lower quality grill that has the accessories that he or she desires.

In addition to the above, many grill users desire that their grills be capable of additional functions. The increase in outdoor cooking over the last few years has resulted in many users desiring that their grills serve many of the functions that are available in their kitchens. However, in reality, most outdoor grillers utilize the cook box of a grill for cooking a main course for a meal, and then run back and forth between a grill and an indoor kitchen for other cooking needs.

Many grillers prepare several main courses at one time to satisfy a variety of tastes. For example, a griller may utilize the cook box of the grill to prepare steaks, chicken, hot dogs, and hamburgers all at once. Some main dishes, however, are better prepared in other ways. For instance, many dishes are better prepared in a rotisserie. A rotisserie that can be used in conjunction with a grill, therefore, provides an advantage to grillers who wish to get the most out of their grilling experience.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a rotisserie for a grill is provided. The rotisserie includes a cooking chamber, a rotisserie motor, a burner and a spit. The spit extends horizontally inside the cooking chamber and is turned slowly by the rotisserie motor. The burner is positioned along one side of the cooking chamber away from the drip line of any food held on the spit.

In accordance with an embodiment, the spit may be removed and replaced by a grate and a heat shield. The grate supports food above the burner while the heat shield is positioned at an angle to direct heat from the burner to the grate so that items on the grate are cooked in an even manner.

Other features of the invention will become apparent from the following detailed description when taken in conjunction with the drawings, in which:

### BRIEF DESCRIPTION OF THE DRAWINGS

FIG. 1 is a side perspective view of a rotisserie in accordance with an embodiment;

FIG. 2 is a side perspective view of the rotisserie of FIG. 1 showing the back side of the rotisserie;

FIG. 3 is a side cutaway view of the rotisserie of FIG. 1, taken along the section lines 3-3 in FIG. 1;

FIG. 4 is a side perspective view of the rotisserie of FIG. 1 with portions of the rotisserie removed so that the interior of the rotisserie is visible;

FIG. 5 is a side perspective view of a grate and a heat shield of the rotisserie of FIG. 1;

FIG. 6 is a side cutaway view of the rotisserie of FIG. 1, similar to FIG. 7, but with a spit installed; and

FIG. 7 is a bottom view of the rotisserie of FIG. 1.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

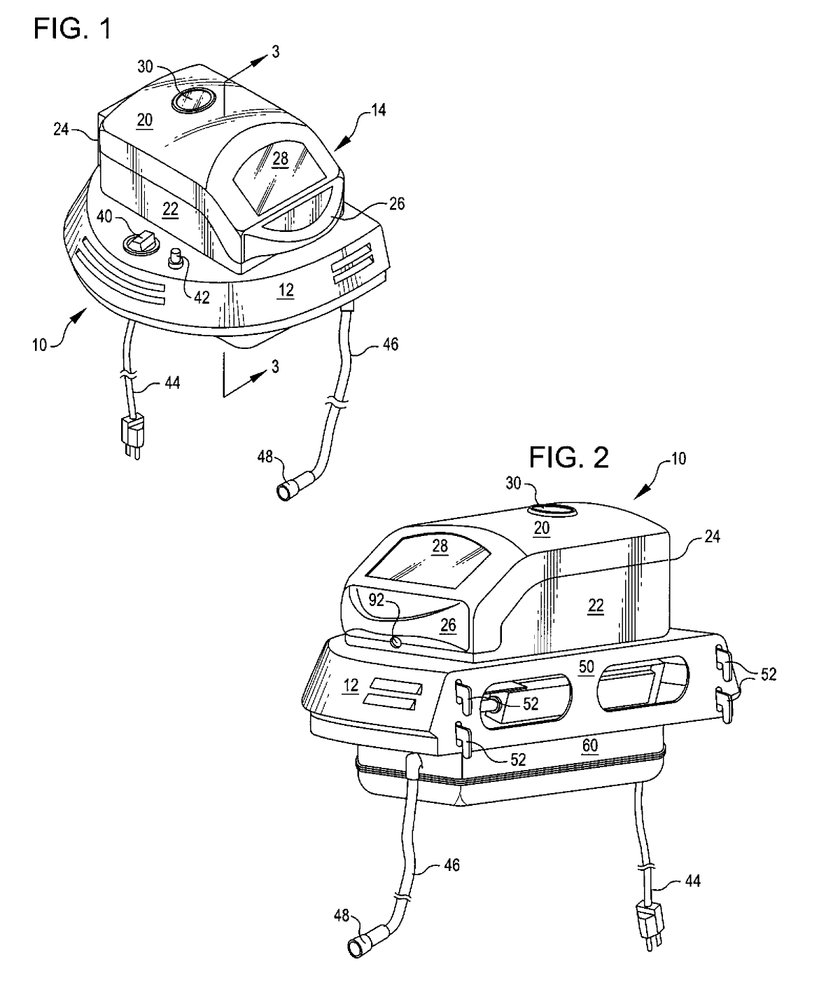

Referring now to the drawings, in which like reference numerals represent like parts throughout the several views, FIG. 1 shows a rotisserie 10 in accordance with an embodiment. The rotisserie 10 includes a base 12 which partially surrounds a cooking chamber 14. The cooking chamber 14 is shaped substantially in the form of a rectangular box and includes a top portion 20 and a bottom portion 22 rotatably connected together along a common edge by a hinge 24. A handle 26 is attached to the end of the top portion 20 opposite the hinge 24 and provides a grip for rotating the top portion 20 about the hinge 24 relative to the bottom 22. The handle 26 may be formed from a heat insulating material such as wood or plastic. The top portion 20 may include convenience items such as a viewing window 28 made from transparent heat resistant glass and a temperature gauge 30 for indicating the temperature inside the cooking chamber 14.

The base 12 may be constructed from a piece of material, such as metal or plastic, and may be formed to surround the vertical surfaces of the cooking chamber 14 in an aesthetically pleasing manner. The base 12 may include components of the rotisserie 10 such as a temperature control knob 40, an igniter 42, a power cord 44, and a gas conduit 46. The gas conduit 46 may include a quick-connect coupling 48 so that the gas conduit 46 may be easily attached to a fuel source, such as a propane tank configured to receive the quick-connect coupling 48. A threaded coupling, or other mechanism, may also be used. As shown in FIG. 2, the base 12 may include a mounting surface 50 from which a series of downward-pointing hooks 52 extend. In an embodiment, the mounting surface 50 comprises a flat, vertical, rectangular surface and the hooks 52 are configured to be received by slots (not shown) in a grill (not shown), the slots in the grill being configured so that the hooks 52 and the mounting surface 50 support the rotisserie 10 on the grill. The hooks 52 may be configured to fit into, for example, the slots 212 in the grill 200 in the PCT application cited in the background section of this document.

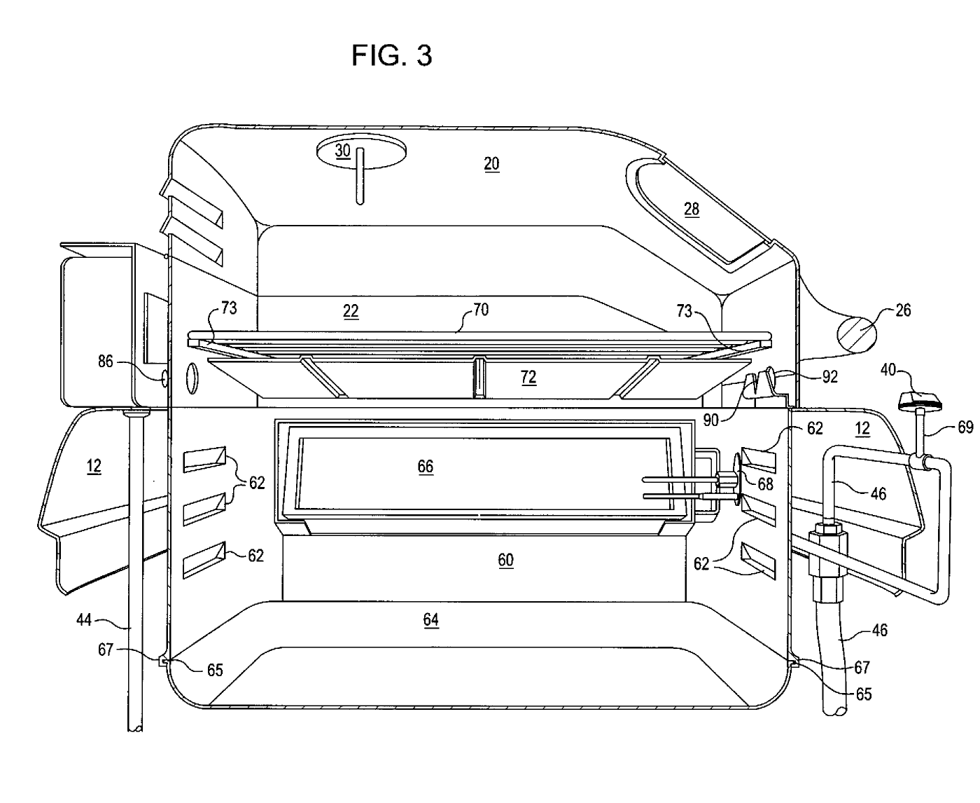

The cooking chamber 14 includes a tub 60 (FIG. 2), which may be a basin formed from a heat-resistant material, such as metal. As shown in FIG. 3, the tub 60 may have a series of vents 62 on one or more vertical sides of the tub to allow for the free passage of gas in and out of the cooking chamber 14. The bottom of the tub 60 may form a removable drip pan 64 having a peripheral upper edge 65 secured to the tub 60 by nesting into a groove 67 located along a lower edge of the tub 60. Inside the tub 60, in an embodiment, a burner 66 is positioned adjacent to the mounting surface 50, although it may be positioned in other parts of the cooking chamber 14, or positioned outside the cooking chamber 14 in a manner such that the burner heats the interior of the cooking chamber 14. The burner 66 may be a ceramic burner, a propane burner, a catalytic burner, an electrical burner or, in general, any device capable of emitting heat.

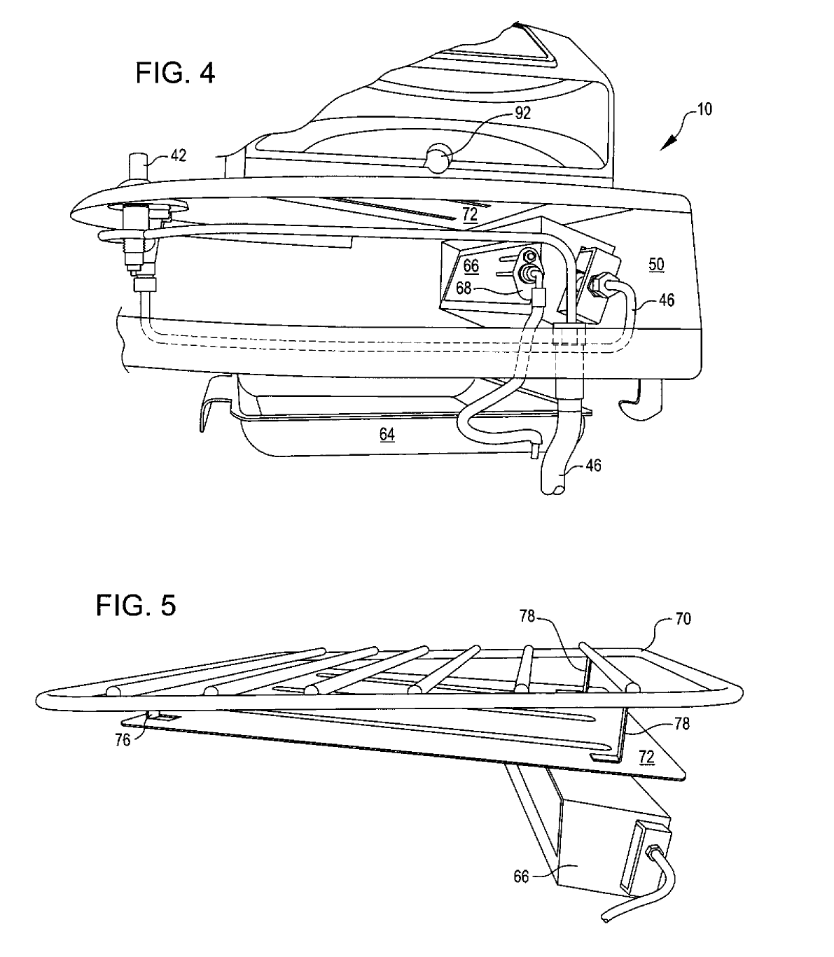

The burner 66 is fluidly connected to the gas conduit 46 so that gas may flow from a fuel source (not shown), such as a liquid propane (LP) fuel canister to the burner 66. The flow of gas to the burner 66 may be regulated by the control knob 40 (shown in FIG. 1) which opens and closes a valve 69 for controlling the flow of gas through the valve 69. As shown in FIG. 3, an electrode 68 may be positioned near the burner 66. The electrode 68 may be a typical electrode known in the grill art, which may be configured to emit a spark near the burner 66 in order to ignite gasses emitted by the burner 66. In an embodiment, the electrode 68 is electrically connected to the igniter 42 (shown in FIG. 1) mounted on the base 12 so that pushing the igniter 42 causes a spark to be emitted by the electrode 68. As shown in FIG. 4, the burner 66 is positioned away from the center of the tub 60 along a vertical side of the tub 60 which may be the side of the tub 60 adjacent the mounting surface 50.

As shown in FIG. 3, in accordance with an embodiment, the rotisserie 10 includes a grate 70, attached to a heat shield 72 above the burner 66. As shown in FIG. 5, the grate 70 may be formed from a series of metallic or ceramic rods spaced parallel a short distance apart on a common plane, although other designs for a grate may be used. The heat shield 72 may be a substantially flat metallic sheet. As shown in FIG. 5, the heat shield 72 may be attached to the grate 70 on one side by a pair of short legs 76 and on an opposite side by a pair of longer legs 78 so that there is an angle between the grate 70 and the heat shield 72. Referring to FIG. 3, in an embodiment, this angle is approximately 15 degrees and the long legs 78 are positioned above the burner 66 so that the heat shield 72 slopes upward away from the burner 66.

Because the burner 66 is located along one side of the rotisserie 10, positioning the heat shield 72 at an angle to the grate 70 allows heat emitted from the burner 66 to be dispersed by the heat shield 72 evenly about the grate 70 instead of the area of the grate 70 closest to the burner 66 receiving more heat than other areas. In particular, because hot gasses rise, the heat shield 72 prevents hot gasses from the burner 66 from traveling directly upward to the portion of the grate 70 directly above the burner 66. Instead, the hot gasses from the burner 66 are directed upward, away from the burner 66 at an angle defined by the angle between the heat shield 72 and grate 70. This process causes the air immediately below the heat shield 72 to achieve an approximately uniform temperature. When the air below the heat shield is heated, heat passes through the heat shield 72 and, because the air below the heat shield 72 is at an approximately uniform temperature, the grate 70 is heated evenly. Depending on the insulating properties of any particular heat shield, the angle between the heat shield 72 and the grate 70 may be adjusted. For example, to prepare for manufacture, a heat shield 72 and grate 70 may be placed over a burner and the angle between the heat shield 72 and grate 70 may be adjusted until a uniform temperature is achieved at the grate 70. The rotisserie 10 may also include a structure (not shown) to allow users to adjust the angle between the grate 70 and the heat shield 72 so that, if the insulating properties of the heat shield 72 change after the rotisserie 10 is used several times, a user may adjust the angle accordingly. The heat shield 72 may also include slots, holes, fins, or other structures for directing the flow of heat to the grate 70. The heat shield 72 may also be curved, contain bends, or have other geometric shapes in order to control heat to the grate 70.

In an embodiment, the grate 70 and heat shield 72 are easily removable from the rotisserie 10 by pulling the grate 70 and heat shield 72 up and out of the bottom 22 of the cooking chamber 14. For example, the grate 70 may hang from a ridge 73 or other structure inside the cooking chamber 14 and the heat shield 72 may hang from the grate 70. The rotisserie 10 may include other structures or mechanisms so that the distance between the grate 70 and the burner 66 may be varied by a user.

With the grate 70 and the heat shield 72 installed, the rotisserie 10 may be used as a conventional oven, for example, for baking or roasting items. In particular, items to be cooked, such as meat, vegetables, breads, and other items, may be placed on the grate 70 and the burner 60 may be ignited. The temperature inside the cooking chamber 14 may be monitored with the temperature gauge 30 and the temperature may be adjusted by regulating the flow of gas with the control knob 40. A control mechanism (not shown) for maintaining a preset temperature, may also be incorporated into the rotisserie 10.

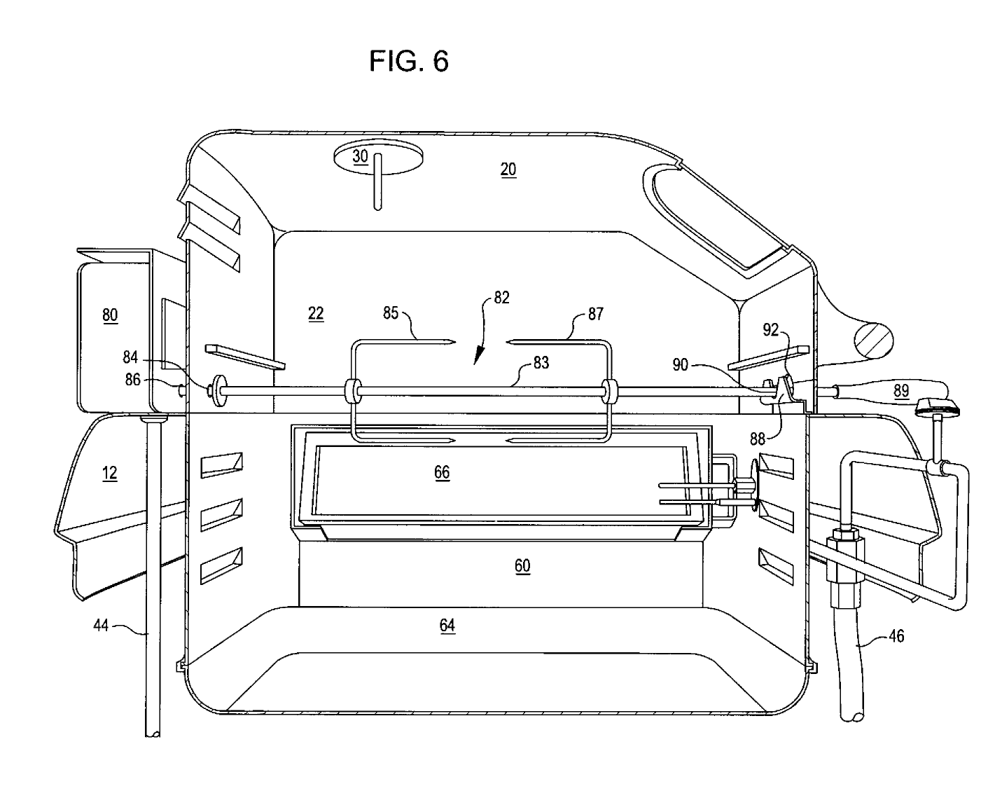

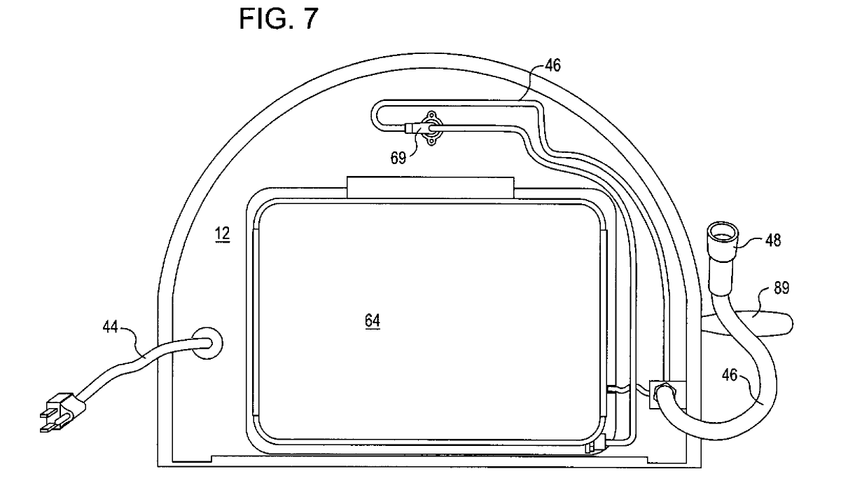

In accordance with an embodiment, as shown in FIG. 6, the rotisserie 10 includes a motor assembly 80 and a removable spit 82. The spit 82 includes an elongated axle 83 of metal which may be installed when the grate 70 and heat shield 72 are removed. The spit 82 may include two sets of prongs 85, 87 which extend parallel to the spit 82, but in opposing directions, at a distance of a few inches to the axle 83 in order to secure items, such as meat, to the spit 82. The sets of prongs 85, 87 are configured so that rotation of the spit 82 about the axle 83 causes the sets of prongs 85, 87 to rotate about the axle 83. The spit 82 may also include a removable handle 89 formed from insulating material, such as plastic, which surrounds an end of the spit 82.

In an embodiment, the sets of prongs 85, 87 are removable and adjustable along the length of the axle so that the prongs 85, 87 may be used to secure objects of varying size. For example, to attach a whole chicken to the spit 82, the handle 89 may first be removed by pulling the handle 89 off the end of the spit 82. Removing the handle 89 allows the set of prongs 87 to be removed and the axle 83 to be passed through the main body cavity of the chicken until the remaining set of prongs 85 pierces the flesh of the chicken. The removed set of prongs 87 may be inserted onto the end of the axle 83 so that the set of prongs 87 is oriented to pierce the flesh of the side of the chicken not already pierced by prongs 85 and the handle 89 may be inserted back on the end of the spit 82. The set of prongs 87 may then be moved along the axle 83 until the set of prongs 85 pierces the flesh of the chicken. The sets of prongs 85 may include structures, such as thumb screws (not shown) which secure each set of prongs 85 and 87 to a particular location on the axle 83.

The motor assembly 80 may be attached to an outer surface of the bottom 22 of the cooking chamber 14, such as a surface adjacent an end of the burner 66. Motor assemblies are known in the rotisserie art and generally include an electric motor connected to a mechanism, such as a set of gears, for providing rotation at an angular speed less than that produced by the motor. In an embodiment, a hole 84 in the bottom 22 of the cooking chamber 14 is aligned with a hole 86 in the motor assembly 80 and is approximately centered over a wall of the tub 60 adjacent an end of the burner 66. The spit 82 extends through the holes 84, 86 and is mechanically engaged by the motor assembly 80.

In an embodiment, the end of the spit 82 engaged by the motor assembly 80 has a square cross section configured to fit snugly into a socket (not shown) of similar shape of the motor assembly 80 while the opposite end of the spit 82 has a round cross section. A spit receiver 88 is mounted to the side of the bottom 22 of the cooking chamber 14 opposite the motor assembly 80. The spit receiver 88 may be a metallic bracket extending into the cooking chamber 14. As shown in FIG. 6, the spit 82 is suspended inside the cooking chamber 14 by one end of the motor assembly 80 and the other end in a v-shaped cutout 90 of the spit receiver 88. In an embodiment, the motor assembly 80 is powered by alternating current (AC) power through the power cord 44 and rotates the spit 82 at a slow pace, such as two revolutions per minute. The end of the spit 82 opposite the motor assembly 80 freely rotates inside the v-shaped cutout 90 of the spit receiver 88. As an alternative, the motor assembly 80 may be powered by a thermoelectric device which converts heat, such as heat from the burner 66, into electrical energy. Batteries, or other power sources, may also be used.

The spit 82 is installed into the rotisserie 10 by first passing the end of the spit 82 with a square cross section into the holes 84, 86 of the bottom 22 of the cooking chamber 14 and the motor assembly 80, respectively. The end of the spit 82 having a round cross section is then placed into the v-shaped cutout 90 of the spit receiver 88 so that the handle 89 of the spit 82 protrudes through a u-shaped cutout 92 of the bottom 22 of the cooking chamber 14 adjacent the v-shaped cutout 90 of the spit receiver 88.

When the rotisserie 10 with a spit 82 is in use, the motor assembly 80 slowly turns any food on the spit 82 slowly about the axle 83 inside the cooking chamber 14. Because the burner 66 is located along a wall of the cooking chamber 14, the burner 66 is removed from a vertical projection of the spit 82, that is, the burner 66 is not directly below the axle 83 of the spit 82 and any liquids, such as grease, falling from the food does not drip onto the burner 66, but directly into the drip pan 64. This prevents grease from contacting the burner 66 and creating smoke and fire, while allowing the burner to directly heat food secured to the spit 82. After cooking, a user may remove the drip pan 64 for cleaning.

Other mechanisms for removably positioning the spit 82 inside the cooking chamber 14 may also be used. For example, the spit 82 and motor assembly 80 may be attached to a pair of arms (not shown) pivotally attached to a structure of the rotisserie 10 so that the spit and motor assembly may be pivoted into place in the cooking chamber 14, or pivoted out of the way outside the cooking chamber 14 or in an out-of-the-way location in the cooking chamber 14.

As noted above, the rotisserie 10 includes hooks 52 for attaching the rotisserie to a grill. The rotisserie 10, however, may also function as a free standing unit. In particular, the rotisserie may be, for example, placed on a table top and connected to a fuel source and operated. Other structures for attaching to a grill may also be used. For instance, a grill may be configured with a shelf having a hole into which the tub 60 of the rotisserie 10 may be dropped and held in place by gravity.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A rotisserie, comprising:
a cooking chamber;
a motor assembly attached to the cooking chamber;
a first structure for receiving a removable spit having an axle, the axle being mechanically connected to the motor assembly and removably positioned at least partly in the cooking chamber at a first position when the removable spit is received in the first structure;
a burner for emitting heat and positioned to heat an interior of the cooking chamber; and
a second structure for removably receiving at least a portion of a grate within the cooking chamber horizontally above the burner approximately at the first position.

2. The rotisserie of claim 1, wherein the burner comprises a fuel burning burner.

3. The rotisserie of claim 2, wherein the burner is removed from a vertical projection of the spit when the spit is positioned in the cooking chamber, and wherein the rotisserie further comprises:
a removable heat shield configured to be positioned in the cooking chamber below the grate when the grate is installed in the cooking chamber, at least a portion of the heat shield positioned above the burner, the heat shield comprising a surface, wherein at least a portion of the surface extends from a location near the burner towards a portion of the grate removed from a vertical projection of the burner.

4. The rotisserie of claim 3, wherein the grate and the heat shield are configured to be removable as a single unit.

5. The rotisserie of claim 4, further comprising a structure for removably attaching the rotisserie to a grill.

6. The rotisserie of claim 2, wherein the grate and the heat shield are configured to be removable as a single unit.

7. The rotisserie of claim 6, further comprising a structure for removably attaching the rotisserie to a grill.

8. The rotisserie of claim 2, further comprising a structure for removably attaching the rotisserie to a grill.

9. The rotisserie of claim 1, wherein the burner is removed from a vertical projection of the spit when the spit is positioned in the cooking chamber, and wherein the rotisserie further comprises:
a removable heat shield configured to be positioned in the cooking chamber below the grate when the grate is installed in the cooking chamber, at least a portion of the heat shield positioned above the burner, the heat shield comprising a surface, wherein at least a portion of the surface extends from a location near the burner towards a portion of the grate removed from a vertical projection of the burner.

10. The rotisserie of claim 9, wherein the grate and the heat shield are configured to be removable as a single unit.

11. The rotisserie of claim 10, further comprising a structure for removably attaching the rotisserie to a grill.

12. The rotisserie of claim 9, further comprising a structure for removably attaching the rotisserie to a grill.

13. The rotisserie of claim 1, wherein the grate and the heat shield are configured to be removable as a single unit.

14. The rotisserie of claim 13, further comprising a structure for removably attaching the rotisserie to a grill.

15. The rotisserie of claim 1, further comprising a structure for removably attaching the rotisserie to a grill.

16. An oven, comprising:
a cooking chamber having a center portion;
a burner removed from the center portion and positioned to heat an interior of the cooking chamber;
a grate removably positioned in the cooking chamber horizontally above the burner at a position; and
a heat shield, at least a portion of which is above the burner, the heat shield configured to be removed by removal of the grate.

17. The oven of claim 16, further comprising:
a spit removably positioned in the cooking chamber at the position; and
a motor assembly mechanically connected to the spit.

18. The oven of claim 17, further comprising a structure for removably attaching the oven to a grill.

19. A grill, comprising:
a stand;
a firebox;
an oven removably mounted to the grill, the oven comprising:
a cooking chamber having a center portion;
a burner removed from the center portion and positioned to heat an interior of the cooking chamber;
a grate removably positioned in the cooking chamber horizontally above the burner at a position; and
a heat shield, at least a portion of which is above the burner, the heat shield configured to be removed by removal of the grate.

20. The grill of claim 19, wherein the oven further comprises:
a spit removably positioned in the cooking chamber at the position; and
a motor assembly mechanically connected to the spit.
